(19) United States
(12) Patent Application Publication
(10) Pub. No.: US 2007/0264495 A1
(43) Pub. Date: Nov. 15, 2007

(54) Thermoplastic Elastomeric Material Comprising a Vulcanized Rubber in a Subdivided Form

(76) Inventors: Emiliano Resmini, Milano (IT); Diego Tirelli, Milano (IT); Michele Galbusera, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/593,569

(22) PCT Filed: Mar. 29, 2004
(86) PCT No.: PCT/EP04/03302

§ 371 Date: Jun. 26, 2007

(51) Int. Cl. C08L 21/00; C08K 5/09; C08L 25/10; C08L 53/02

(52) U.S. Cl. 428/339; 524/424; 524/426; 524/436; 524/437; 524/505; 525/193; 525/539; 525/97; 525/99

(57) ABSTRACT

A thermoplastic elastomeric material having: (a) 10% by weight to 100% by weight, preferably 20% by weight to 80% by weight, of at least one styrene-based thermoplastic elastomer, (b) 0% by weight to 90% by weight, preferably 20% by weight to 80% by weight, of at least one thermoplastic α-olefin homopolymer or copolymer different from (a), the amount of (a)+(b) being 100; (c) 2 parts by weight to 90 parts by weight, preferably 5 parts by weight to 40 parts by weight, of a vulcanized rubber in a subdivided form; (d) 0.01 part by weight to 10 parts by weight, preferably 0.05 part by weight to 5 parts by weight, of at least one coupling agent containing at least one ethylenic unsaturation, the amounts of (c) and (d) being expressed with respect to 100 parts by weight of (a)+(b). The thermoplastic elastomeric material shows improved mechanical properties, in particular, stress at break and elongation at break. Moreover, the thermoplastic elastomeric material shows improved abrasion resistance.

### BACKGROUND OF THE INVENTION

The present invention relates to a thermoplastic elastomeric material comprising a vulcanized rubber in a subdivided form.

In particular, the present invention relates to a thermoplastic elastomeric material comprising a vulcanized rubber in a subdivided form and at least one styrene-based thermoplastic elastomer.

The present invention moreover relates to a manufactured product comprising said thermoplastic elastomeric material.

### PRIOR ART

The increased production of industrial rubber products has resulted in the accumulation of large amounts of rubber wastes which are generally disposed in dedicated landfills with the main drawbacks of environment pollution as well as of the need for large dedicated areas for storing said wastes.

It is known in the art to depolymerize waste rubber, such as tires, in an effort to reduce the volume of waste and obtain a useful byproduct. Likewise, rubber products may be devulcanized in an attempt to recycle the waste rubber.

In addition to these techniques, it is common in the art to grind the waste rubber and utilize the ground particles so obtained. These ground particles may then be compounded with thermoplastic polymeric materials in order to make final products which may be employed in a plurality of applications.

For example, patent U.S. Pat. No. 4,970,043 relates to a process for forming a stable moldable product from scrap material comprising reground rubber and a cohesive base material comprising a thermoplastic polymer such as, for example, a butadiene-styrene block copolymer. A substantially uniformly distributed mixture of the reground rubber and the cohesive base material in a ratio 1:1 is processed under sufficient pressure and temperature to form a semi-stable moldable product. The semi-stable moldable product is then subjected or maintained under sufficient pressure to form a stable moldable product. The obtained stable molded product is said to have reduced porosity and generally uniform properties.

U.S. Pat. No. 5,514,721 relates to a method for making a reprocessable thermoplastic composition containing a thermoplastic material and vulcanized rubber particles, said method comprising the steps of first melting a thermoplastic material to form a heated mass; adding to said heated mass a deflocculant and an emulsifier for vulcanized rubber particles, said deflocculant being selected from the group consisting of organic and inorganic acid and base deflocculants; adding vulcanized rubber particles to said mass; heating and mixing the resultant mass under high shear forces sufficiently to reduce the particles size of the rubber particles while emulsifying and swelling the surfaces of the same; neutralizing the mixture to its isoelectric point; and cooling and recovering the resultant mass. The thermoplastic material may be selected from thermoplastic elastomers (for example, a styrene block copolymer such as styrene-isoprene or styrene-butadiene block copolymers). The obtained thermoplastic composition can be formulated to have properties comparable to, or better than, vulcanized rubbers and to have excellent chemical and weathering resistance.

U.S. Pat. No. 6,262,175 relates to a thermoplastic composition containing, in percentages by weight based on the total weight of the composition: about 5% to about 90% of vulcanized rubber crumb; about 5% to about 60% polyolefin; about 2% to about 30% uncured rubber or styrene-based thermoplastic elastomer; and about 2% to about 30% vinyl polymer selected from vinyl homopolymers, copolymers and mixtures thereof. The polyolefin is a solid, high molecular weight polyolefin homopolymer or copolymer, or mixtures thereof. Preferred polyolefin are polyethylene, polypropylene, or a copolymer of ethylene and propylene. The styrene-based thermoplastic elastomer may be selected from styrene-butadiene-styrene block copolymers. The abovementioned thermoplastic composition is said to have excellent physical properties, including excellent ultimate elongation and tear strength.

However, the Applicant noticed that the addition of ground vulcanized rubber particles to styrene-based thermoplastic elastomers such as, for example, styrene block copolymers, results in a significant deterioration of the mechanical properties of the resulting thermoplastic elastomeric material.

In particular, the Applicant noticed that the scarce compatibility between the styrene-based thermoplastic elastomers and the ground vulcanized rubber particles negatively affects the mechanical properties, in particular stress at break and elongation at break, and the abrasion resistance of the obtained thermoplastic elastomeric materials.

### SUMMARY OF THE INVENTION

The Applicant has now found that it is possible to overcome the above mentioned problems utilizing at least one coupling agent having at least one ethylenic unsaturation. Said coupling agent improves the compatibility between the styrene-based thermoplastic elastomers and the ground vulcanized rubber particles and allows to obtain a thermoplastic elastomeric material having good mechanical properties, in particular stress at break and elongation at break. Moreover, said thermoplastic elastomeric material shows an improved abrasion resistance. Furthermore, said thermoplastic elastomeric material shows good flexural strength and good tear resistance. Moreover, the Melt Flow Index (MFI) of said thermoplastic elastomeric material is not negatively affected.

According to a first aspect, the present invention relates to a thermoplastic elastomeric material comprising:
(a) from 10% by weight to 100% by weight, preferably from 20% by weight to 80% by weight, of at least one styrene-based thermoplastic elastomer;
(b) from 0% by weight to 90% by weight, preferably from 20% by weight to 80% by weight, of at least one thermoplastic α-olefin homopolymer or copolymer different from (a);
   the amount of (a)+(b) being 100;
(c) from 2 parts by weight to 90 parts by weight, preferably from 5 parts by weight to 40 parts by weight, of a vulcanized rubber in a subdivided form;
(d) from 0.01 parts by weight to 10 parts by weight, preferably from 0.05 parts by weight to 5 parts by weight, of at least one coupling agent containing at least one ethylenic unsaturation;
   the amounts of (c) and (d) being expressed with respect to 100 parts by weight of (a)+(b).

According to one preferred embodiment, said thermoplastic elastomeric material may further comprise (e) at least one aromatic monocarboxylic or dicarboxylic acid or a derivative thereof.

According to a further preferred embodiment, said thermoplastic elastomeric material may further comprise (f) at least one inorganic filler.

According to a further preferred embodiment, said thermoplastic elastomeric material may further comprise (g) at least one syndiotactic 1,2-polybutadiene.

According to one preferred embodiment, the styrene-based thermoplastic elastomer (a) comprises at least two terminal poly(monovinylaromatic hydrocarbon) blocks and at least one internal poly(conjugated diene) block and/or poly(aliphatic α-olefin) block.

Preferably, the styrene-based thermoplastic elastomer (a) may be selected, for example, from block copolymers having the following formulae: A(BA)ₘ, or A(BA′)_{m′}, or (AB)ₙX, or (AB)ₚX(A′B′)_{q} or (AB)ᵣX(B″)ₛ, wherein each of A and A′ independently represent a polymer block comprising a monovinilydene aromatic monomer; B, B′ and B″ independently represent a polymer block comprising a conjugated diene monomer and/or an aliphatic α-olefin monomer; X represents a polyfunctional bridging moiety; n and r represent an integer not lower than 2, preferably from 2 to 20 inclusive, more preferably from 2 to 8 inclusive; m and m′ represent an integer ≧1, preferably from 1 to 20 inclusive, more preferably from 1 to 8 inclusive; p, q and s represent an integer ≧1, preferably from 1 to 20 inclusive, more preferably from 1 to 8 inclusive.

Preferably, the monovinylidene aromatic monomer of blocks A and A′ may be selected, for example, from: styrene, alkyl-substituted styrenes, alkoxy-substituted styrenes, vinyl naphthalene, alkyl-substituted vinyl naphthalene, vinyl xylene, alkyl-substituted vinyl xylene, or mixtures thereof. Styrene or alkyl-substituted styrene are preferred, styrene is more preferred.

The alkyl or alkoxy substituents may generally comprise from 1 to 6 carbon atoms, preferably from 1 to 4 carbon atoms. The number of alkyl or alkoxy substituents per molecule, if present, may range from 1 to 3, and is preferably 1. Comonomers, if present, may be selected from (di)olefins and other compounds copolymerizable with styrene.

Preferably, the conjugated diene monomer of blocks B, B′ and B″, may be selected, for example, from conjugated dienes containing from 4 to 24, preferably from 3 to 12, more preferably from 4 to 6, carbon atoms, such as, for example, 1,3-butadiene, isoprene, 2-ethyl-1,3-butadiene, 2,3-dimethyl-1,3-butadiene, 2-phenyl-1,3-butadiene, 1,3-pentadiene, methylpentadiene, 3-ethyl-1,3-pentadiene, 2,4-hexadiene, 3,4-dimethyl-1,3-hexadiene, 4,5-diethyl-1,3-octadiene, piperylene, or mixtures thereof. 1,3-Butadiene and isoprene are preferred. Comonomers, if present, may be selected from vinylaromatic monomers and other compounds copolymerizable with the conjugated diene monomers.

Preferably, the aliphatic α-olefin monomer may contain from 2 to 12, more preferably from 2 to 4, carbon atoms and may be selected, for example, from: ethylene, propylene, or mixture thereof.

Preferably, the A and A′ blocks represent poly(styrene) blocks and B, B′ and B″ blocks represent poly(butadiene) blocks, poly(isoprene) blocks, polybutylene/polyethylene copolymer blocks, polyethylene/polypropylene copolymer blocks, or isoprene/butadiene copolymer blocks.

Polyfunctional bridging moieties which may be used comprise those commonly known in the art.

Examples of suitable polyfunctional bridging moieties which may be advantageously used in said block copolymers comprises from 2 to 8, preferably from 2 to 6, more preferably 2, 3 or 4, functional groups.

Said blocks copolymers may be made by anionic polymerization with an alkali metal initiator such as s-butyllithium as disclosed, for example, in U.S. Pat. No. 4,764,572, U.S. Pat. No. 3,231,635, U.S. Pat. No. 3,700,633 and U.S. Pat. No. 5,194,530.

Said block copolymers may also be selectively hydrogenated, usually to a residual ethylenic unsaturation of at most 20%, more preferably at most 5%, still more preferably at most 2% of its original unsaturation content prior to hydrogenation. Hydrogenation may be carried out as disclosed, for example, in U.S. Pat. Reissue 27,145 or in patents U.S. Pat. No. 5,039,755, U.S. Pat. No. 5,299,464 and U.S. Pat. No. 3,595,942.

Preferably, blocks A and A′ have a weight average molecular weight in the range of from 3,000 g/mol to 125,000 g/mol, more preferably from 5,000 g/mol to 60,000 g/mol.

Preferably, the blocks B, B′ and B″, have a weight average molecular weight in the range of from 10,000 g/mol to 300,000 g/mol, more preferably in the range of from 30,000 g/mol to 150,000 g/mol.

The total weight average molecular weight of the block copolymer is preferably in the range of from 25,000 to 500,000, more preferably from 35,000 to 400,000.

The weight average molecular weight may be determined by methods known in the art such as, for example, by gel permeation chromatography (GPC) using polystyrene calibration standards according to ASTM standard D3536-91.

The amount of the monovinylidene aromatic blocks is generally of from 8% by weight to 75% by weight, preferably from 20% by weight to 60% by weight, with respect to the total weight of the block copolymer. Preferably, the block copolymer contains from 25% by weight to 92% by weight, more preferably from 40% by weight to 80% of conjugated diene block and/or of aliphatic α-olefin block, with respect to the total weight of the block copolymer.

Said block copolymer have a triblock structure and may be of the linear or radial type, or any combination thereof.

Preferably, the styrene-based thermoplastic elastomer (a) may be selected, for example, from the following triblock copolymers: styrene-butadiene-styrene (S-B-S), styrene-isoprene-styrene (S-I-S), styrene-ethylene/butene-styrene (S-EB-S), or mixtures thereof.

Examples of styrene-based thermoplastic elastomer (a) which may be used in the present invention and which are currently commercially available are the products Kraton® (Shell Chemical), Calprene® (Repsol); Europrene® (Polimeri Europa); Vector® (Dexco).

With regard to the thermoplastic α-olefin homopolymer or copolymer (b), different from (a), the term “α-olefin” generally means an aliphatic or aromatic α-olefin of formula CH₂═CH—R, wherein R represents a hydrogen atom, a linear or branched alkyl group containing from 1 to 12 carbon atoms, an aryl group having from 6 to 14 carbon atoms.

Preferably, the aliphatic α-olefin may be selected, for example, from: ethylene, propylene, 1-butene, isoprene, isobutylene, 1-pentene, 1-hexene, 3-methyl-1-butene, 3-methyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene, 1-eicosene, or mixture thereof. Of these, preferred are ethylene, propylene, 1-butene, 1-hexene, 1-octene, or mixtures thereof.

Preferably, the aromatic α-olefin may be selected, for example, from: styrene, α-methylstyrene, or mixture thereof.

Preferably, the thermoplastic α-olefin homopolymer or copolymer (b) which may be used in the present invention may be selected, for example, from:
propylene homopolymers or copolymer of propylene with ethylene and/or at least one α-olefin having from 4 to 12 carbon atoms with an overall content of ethylene and/or α-olefin lower than 10% by mole;
ethylene homopolymers or copolymers of ethylene with at least one α-olefin having from 4 to 12 carbon atoms and, optionally, at least one polyene;

styrene polymers such as, for example, styrene homopolymers; copolymers of styrene with at least one C₁-C₄ alkyl-styrene or with at least one natural or synthetic elastomer such as, for example, polybutadiene, polyisoprene, butyl rubber, ethylene/propylene/diene copolymer (EPDM), ethylene/propylene copolymers (EPR), natural rubber, epichlorohydrin;

copolymers of ethylene with at least one ethylenically unsaturated ester selected from: alkyl acrylates, alkyl methacrylates and vinyl carboxylate, wherein the alkyl group, linear or branched, may have from 1 to 8, preferably from 1 to 4, carbon atoms, while the carboxylate group, linear or branched, may have from 2 to 8, preferably from 2 to 5, carbon atoms; and wherein the ethylenically unsaturated ester is generally present in an amount of from 0.1% to 80% by weight, preferably from 0.5% to 50% by weight, with respect to the total weight of the copolymer.

Examples of ethylene homopolymers or copolymers of ethylene with at least one α-olefin having from 4 to 12 carbon atoms which may be used in the present invention as thermoplastic α-olefin homopolymer or copolymer (b) are: low density polyethylene (LDPE), medium density polyethylene (MDPE), high density polyethylene (HDPE), linear low density polyethylene (LLDPE), ultra-low density polyethylene (ULDPE), or mixtures thereof.

Preferably, the copolymers of ethylene with at least one α-olefin having from 4 to 12 carbon atoms may be selected, for example, from:
elastomeric copolymers having the following monomer composition: 35 mol %-90 mol % of ethylene; 10 mol %-65 mol % of an aliphatic α-olefin, preferably propylene; 0 mol %-10 mol % of a polyene, preferably a diene, more preferably, 1,4-hexadiene or 5-ethylene-2-norbornene (for example, EPR and EPDM rubbers);
copolymers having the following monomer composition: 75 mol %-97 mol %, preferably 90 mol %-95 mol %, of ethylene; 3 mol %-25 mol %, preferably 5 mol %-10 mol %, of an aliphatic α-olefin; 0 mol %-5 mol %, preferably 0 mol %-2 mol %, of a polyene, preferably a diene (for example, ethylene/1-octene copolymers, such as the products Engage® of DuPont-Dow Elastomers).

Examples of styrene polymers, different from (a), which may be used in the present invention are: syndiotactic polystyrene, atactic polystyrene, isotactic polystyrene, styrene-methylstyrene copolymer, styrene-isoprene copolymer or styrene-butadiene copolymer, styrene-ethylene/propylene (S-EP) or styrene-ethylene/butene (S-EB) diblock copolymers; styrene-butadiene or styrene-isoprene branched copolymers; or mixtures thereof.

With regard to the copolymers of ethylene with at least one ethylenically unsaturated ester, examples of acrylates or methacrylates are: ethyl acrylate, methyl acrylate, methyl methacrylate, t-butyl acrylate, n-butyl acrylate, n-butyl methacrylate, 2-ethylhexyl acrylate, or mixtures thereof. Examples of vinyl carboxylates are: vinyl acetate, vinyl propionate, vinyl butanoate, or mixtures thereof.

Examples of copolymers of ethylene with at least one ethylenically unsaturated ester which may be used in the present invention are: ethylene/vinylacetate copolymer (EVA), ethylene/ethylacrylate copolymer (EEA), ethylene/butylacrylate copolymer (EBA), or mixtures thereof.

Said thermoplastic α-olefin homopolymer or copolymer (b) may be recovered from a waste material such as, for example, from industrial wastes, from used agricultural films, from used bottles or containers.

The vulcanized rubber in a subdivided form (c) which may be used in the present invention may be obtained by grinding or otherwise comminuting any source of vulcanized rubber compound such as, for example, tires, roofing membranes, hoses, gaskets, and the like, and is preferably obtained from reclaimed or scrap tires using any conventional method. For example, the vulcanized rubber in a subdivided form may be obtained by mechanical grinding at ambient temperature or in the presence of a cryogenic coolant (i.e. liquid nitrogen). Any steel or other metallic inclusions should be removed from the ground tires before use. Usually, fibrous material such as, for example, tire cord fibers, is preferably removed from the ground rubber using conventional separation methods.

According to one preferred embodiment, the vulcanized rubber in a subdivided form (c) which may be used in the present invention, is in the form of powder or granules having a particle size not higher than 10 mm, preferably not higher than 5 mm.

According to a more preferred embodiment, the vulcanized rubber in a subdivided form (c) which may be used in the present invention, has a particle size not higher than 0.5 mm, preferably not higher than 0.2 mm, more preferably not higher than 0.1 mm.

According to one preferred embodiment, the vulcanized rubber in a subdivided form (c) may comprise at least one crosslinked diene elastomeric polymer or copolymer which may be of natural origin or may be obtained by solution polymerization, emulsion polymerization or gas-phase polymerization of one or more conjugated diolefins, optionally blended with at least one comonomer selected from monovinylarenes and/or polar comonomers in an amount of not more than 60% by weight.

The conjugated diolefins generally contain from 4 to 12, preferably from 4 to 8 carbon atoms, and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene, or mixtures thereof. Monovinylarenes which may optionally be used as comonomers generally contain from 8 to 20, preferably from 8 to 12 carbon atoms, and may be selected, for example, from: styrene; 1-vinylnaphthalene; 2-vinylnaphthalene; various alkyl, cycloalkyl, aryl, alkylaryl or arylalkyl derivatives of styrene such as, for example, α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, or mixtures thereof.

Polar comonomers which may optionally be used may be selected, for example, from: vinylpyridine, vinylquinoline, acrylic acid and alkylacrylic acid esters, nitriles, or mixtures thereof, such as, for example, methyl acrylate, ethyl acrylate, methyl methacrylate, ethyl methacrylate, acrylonitrile, or mixtures thereof.

Preferably, the crosslinked diene elastomeric polymer or copolymer may be selected, for example, from: cis-1,4-polyisoprene (natural or synthetic, preferably natural rubber), 3,4-polyisoprene, polybutadiene (in particular polybutadiene with a high 1,4-cis content), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

Alternatively, the vulcanized rubber in a subdivided form (c) may further comprise at least one crosslinked elastomeric polymer of one or more monoolefins with an olefinic comonomer or derivatives thereof. The monoolefins may be selected, for example, from: ethylene and α-olefins generally containing from 3 to 12 carbon atoms, such as, for example, propylene, 1-butene, 1-pentene, 1-hexene, 1-octene, or mixtures thereof. The following are preferred: copolymers between ethylene and an α-olefin, optionally with a diene; isobutene homopolymers or copolymers thereof with small amounts of a diene, which are optionally at least partially halogenated. The diene optionally present generally contains from 4 to 20 carbon atoms and is preferably selected from: 1,3-butadiene, isoprene, 1,4-hexadiene, 1,4-cyclohexadiene, 5-ethylidene-2-norbornene, 5-methylene-2-norbornene, vinylnorbornene, or mixtures thereof. Among these, the following are particularly preferred: ethylene/propylene copolymers (EPR) or ethylene/propylene/diene copolymers (EPDM); polyisobutene; butyl rubbers; halobutyl rubbers, in particular chlorobutyl or bromobutyl rubbers; or mixtures thereof.

According to one preferred embodiment, the coupling agent containing at least one ethylenic unsaturation (d), may be selected from those known in the art such as, for example: silane compounds containing at least one ethylenic unsaturation and at least one hydrolyzable group; epoxides containing at least one ethylenic unsaturation; monocarboxylic acids or, preferably, dicarboxylic acids containing at least one ethylenic unsaturation, or derivatives thereof, in particular anhydrides or esters; organic titanates, zirconates or aluminates containing at least one ethylenic unsaturation; or mixtures thereof.

Preferably, the silane compounds may be selected, for example, from: γ-methacryloxypropyltrimethoxysilane, methyltriethoxysilane, methyltris(2-methoxyethoxy)silane, dimethyldiethoxysilane, vinyltris(2-methoxyethoxy)silane, vinyltrimethoxysilane, vinyltriethoxysilane, octyltriethoxysilane, isobutyltriethoxysilane, isobutyltrimethoxysilane, or mixtures thereof.

Preferably, the epoxides may be selected, for example, from: glycidyl acrylate, glycidyl methacrylate, monoglycidyl ester of itaconic acid, glycidyl ester of maleic acid, vinyl glycidyl ether, allyl glycidyl ether, or mixtures thereof.

Preferably, the monocarboxylic or dicarboxylic acids, or derivatives thereof, may be selected, for example, from: maleic acid, maleic anhydride, fumaric acid, citraconic acid, itaconic acid, acrylic acid, methacrylic acid, and anhydrides or esters derived therefrom, or mixtures thereof. Maleic anhydride is particularly preferred.

In order to further improving the compatibility between the vulcanized rubber in a subdivided form (c) and the styrene-based thermoplastic elastomer (a), the thermoplastic elastomeric material according to the present invention may further comprise at least one aromatic monocarboxylic or dicarboxylic acid or a derivative thereof (e) such as, an anhydride or an ester.

Aromatic monocarboxylic or dicarboxylic acid or a derivative thereof (e) which may be used according to the present invention may be selected, for example, from: benzoic acid, phthalic acid, phthalic anhydride, trimellitic anhydride, di-2-ethylhexyl phthalate, di-isodecyl phthalate, tris-2-ethylhexyl trimellitate, or mixtures thereof.

According to one preferred embodiment, the aromatic monocarboxylic or dicarboxylic acids or derivatives thereof (e) is present in the thermoplastic elastomeric material of the present invention in an amount of from 0 parts by weight to 10 parts by weight, preferably from 0.01 parts by weight to 5 parts by weight, with respect to 100 parts by weight of (a)+(b).

According to one preferred embodiment, the thermoplastic elastomeric material according to the present invention may further comprise at least one inorganic filler (f).

Inorganic fillers (f) which may be used according to the present invention may be selected, for example, from: hydroxides, hydrated oxides, salts or hydrated salts of metals, in particular, of calcium, magnesium or aluminium, optionally in admixture with other inorganic fillers such as, for example, silicates, carbon black, or mixtures thereof.

Specific examples of suitable inorganic fillers are: magnesium hydroxide, aluminium hydroxide, aluminium oxide (including kaolin, i.e. an aluminium silicate), aluminium trihydrate, magnesium carbonate hydrate, magnesium carbonate, calcium carbonate hydrate, calcium carbonate, magnesium calcium carbonate hydrate, magnesium calcium carbonate, or mixture thereof. Said inorganic fillers (f) are preferably used in the form of particles with sizes ranging from 0.1 μm to 50 μm, preferably from 1 μm to 25 μm.

According to one preferred embodiment, the inorganic filler (f) is present in the thermoplastic elastomeric material of the present invention in an amount from 0 parts by weight to 200 parts by weight, preferably from 10 parts by weight to 50 parts by weight, with respect to 100 parts by weight of (a)+(b).

According to one preferred embodiment, the thermoplastic elastomeric material according to the present invention, in order to increase its opacity, may further comprise at least one syndiotactic 1,2-polybutadiene (g).

Preferably, the syndiotactic 1,2-polybutadiene may have an average molecular weight (number-average), which may be determined, for example, by gel permeation chromatography (GPC), of from 75,000 to 200,000, preferably from 100,000 to 150,000. Preferably, said 1,2-polybutadiene has a crystallinity degree of from 10% to 90%, preferably from 20% to 40%.

According to one preferred embodiment, the syndiotactic 1,2-polybutadiene (g) is present in the thermoplastic elastomeric material of the present invention in an amount of from 0 parts by weight to 300 parts by weight, preferably from 5 parts by weight to 200 parts by weight, with respect to 100 parts by weight of (a)+(b).

In the case the styrene-based thermoplastic elastomer (a) does not include conjugated diene monomers, at least one coupling agent (d) may be added to the thermoplastic elastomeric material according to the present invention, in combination with at least one radical initiator (h), so as to graft the coupling agent (d) directly onto the styrene-based thermoplastic elastomer (a). An organic peroxides such as, for example, t-butyl perbenzoate, dicumyl peroxide, benzoyl peroxide, di-t-butyl peroxide, or mixtures thereof may, for example, be used as a radical initiator (h).

The amount of radical initiator (h) which may be added to the thermoplastic elastomeric material of the present invention is, generally, of from 0 parts by weight to 5 parts by weight, preferably from 0.01 parts by weight to 2 parts by weight, with respect to 100 parts by weight of (a)+(b).

It has to be noted that, in the case the styrene-based thermoplastic elastomer (a) includes conjugated diene monomers, the radical initiator (h) is not necessary. As a matter of fact, the addition of said radical initiator (h) may cause a crosslinking of the styrene-based thermoplastic elastomer (a) (scorching phenomena) which may negatively affect the Melt Flow Index (MFI) of the obtained thermoplastic elastomeric material. Consequently, in the case the styrene-based thermoplastic elastomer (a) includes conjugated diene monomers, the thermoplastic elastomeric material according to the present invention, is substantially devoid of a radical initiator (h).

For the aim of the present description and of the following claims, the term “substantially devoid of radical initiator (h)” means that, if present, the amount of the radical initiator (h) is not higher than 0.2 parts by weight with respect to 100 parts by weight of (a)+(b).

The thermoplastic elastomeric material according to the present invention may further comprises conventional additives such as lubricants (such as, for example, paraffinic or naphthenic oils), pigments, plasticizers, surface-modifying agents, UV absorbers, antioxidants, hindered amine or amide light stabilizers, or mixtures thereof.

Said thermoplastic elastomeric material may be prepared by first mixing the rubber vulcanized in a subdivided form (c), the styrene-based thermoplastic elastomer (a) and the coupling agent containing at least one ethylenic unsaturation (d). After said first mixing step, the other ingredients optionally present may be added to the thermoplastic elastomeric material. The mixing may be carried out according to techniques known in the art such as, for example, using an open-mill mixer or an internal mixer of the type with tangential rotors (Banbury) or interlocking rotors (Intermix), or in continuous mixers of the Ko-Kneader type (Buss) or co-rotating or counter-rotating twin-screw type. The obtained thermoplastic elastomeric material may then be extruded and palletized according to usual techniques. The pellets may be either packaged for future use or used immediately in a process of forming a manufactured product. The pellets or blends of the present invention may be formed into manufactured products according techniques known in the art for thermal processing of thermoplastic resin compositions. For example, compression molding, vacuum molding, injection molding, calendering, casting, extrusion, filament winding, laminating, rotational or slush molding, transfer molding, lay-up or contact molding, stamping, or combinations of these methods, may be used.

According to a further aspect, the present invention also relates to a manufactured product obtained by molding the thermoplastic elastomeric material above disclosed.

The thermoplastic elastomeric material according to the present invention may be used in the manufacture of a wide variety of shoes including canvas shoes, sport shoes, and dress shoes. In particular, said thermoplastic elastomeric material may be used for the purpose of soiling, innersoles, and the like.

Moreover, the thermoplastic elastomeric material according to the present invention may also be use in order to make, for example, belts such as, conveyor belts, power belts or driving belts; flooring and footpaths which may be used for recreational area, for industrial area, for sport or safety surfaces; flooring tiles; mats such as, anti-static computer mats, automotive floor mats; mounting pads; shock absorbers sheetings; sound barriers; membrane protections; carpet underlay; automotive bumpers; wheel arch liner; seals such as, automotive door or window seals; o-rings; gaskets; watering systems; pipes or hoses materials; flower pots; building blocks; roofing materials; geomembranes; and the like.

Alternatively, the thermoplastic elastomeric material according to the present invention, may be used in asphalt composition.

### DETAILED DESCRIPTION OF THE PREFERRED EMBODIMENTS

The present invention will be further illustrated below by means of a number of preparation examples, which are given for purely indicative purposes and without any limitation of this invention.

### EXAMPLES 1-3

Preparation of the Thermoplastic Elastomeric Materials

The thermoplastic elastomeric materials given in Table 1 were prepared as follows.

The Europrene® SOL T171 (a), the vulcanized rubber (c) and the maleic anhydride (d), were mixed together in an internal mixer (model Pomini PL 1.6) for about 2 min. As soon as the temperature reached 190° C., a degassing step of 1 minutes was carried out, then the mixture was discharged. The obtained mixture was subsequently charged in an open roll mixer operating at a temperature of 150° C. in order to obtain a sheet 1 mm thick.

TABLE 1

EXAMPLE

| | 1⁽*⁾ | 2 |
|---|---|---|
| Europrene ® SOL T171 | 100 | 100 |
| Vulcanized rubber⁽¹⁾ | 19.9 | 19.9 |
| Maleic anhydride⁽¹⁾ | — | 2.0 |

⁽*⁾comparative;
⁽¹⁾parts by weight with respect to 100 parts by weight of (a).

Europrene® SOL T171:styrene-butadiene-styrene triblock copolymer of radial type containing about 43% by weight of styrene block and 50 phr of aromatic oil (Polimeri Europa);
Vulcanized rubber: cryogenically ground waste rubber from scrap tires (<0.1 mm (140 mesh)—Applied Cryogenics International AG).

Plates 1 mm thick were formed from the thermoplastic material obtained as disclosed above. The plates were prepared by molding for 10 minutes at 180° C. and subsequent cooling for 5 minutes to room temperature.

The plates were used for determining the mechanical characteristics (i.e. stress at break and elongation at break) according to ASTM D638-02a Standard with the Instron instrument at a traction speed of 50 mm/min. The obtained results are given in Table 2.

Moreover, the DIN abrasion values were measured according to DIN 53516 Standard, also reported in Table 2, expressed as the amount of compound removed.

Furthermore, the Melt Flow Index (MFI) according to ASTM D1238-01e1 Standard, under 5 Kg and at a temperature of 190° C., was measured: the obtained data are given in Table 2.

TABLE 2

EXAMPLE

| | 1(*) | 2 |
|---|---|---|
| Stress at break (MPa) | 5.7 | 7.1 |
| Elongation at break (%) | 837 | 896 |
| DIN abrasion (mm³) | 108 | 92 |
| MFI (5 Kg - 190° C.) | 2.9 | 1.7 |

(*)comparative.

The data reported in Table 2 show that the thermoplastic elastomeric material according to the present invention (Example 2) has, with respect to the comparative composition comprising a vulcanized rubber in a subdivided form devoid of the coupling agent (Example 1), improved mechanical properties, in particular stress at break and elongation at break and improved abrasion resistance. Moreover, the Melt Flow Index (MFI) is not negatively affected.

### EXAMPLES 3-4

Preparation of the Thermoplastic Elastomeric Materials

The thermoplastic elastomeric materials given in Table 3 were prepared as follows.

The Europrene® SOL T171 (a), the vulcanized rubber (c) and the maleic anhydride (d), were mixed together in an internal mixer (model Pomini PL 1.6) for about 2 min. As soon as the temperature reached 190° C., a degassing step of 1 minutes was carried out, the polystyrene (b) was then added and the mixture was mixed for about 5 min. Then the mixture was discharged. The obtained mixture was subsequently charged in an open roll mixer operating at a temperature of 15° C. in order to obtain a sheet 1 mm thick.

TABLE 3

EXAMPLE

| | 3⁽*⁾ | 4 |
|---|---|---|
| Europrene ® SOL T171⁽¹⁾ | 65.9 | 65.9 |
| Polystyrene⁽¹⁾ | 34.1 | 34.1 |
| Vulcanized rubber⁽²⁾ | 23.3 | 23.3 |
| Maleic anhydride⁽²⁾ | — | 2.3 |

⁽*⁾comparative;
⁽¹⁾amount of (a) + (b) = 100;
⁽²⁾parts by weight with respect to 100 parts by weight of (a) + (b).

Europrene® SOL T171: styrene-butadiene-styrene triblock copolymer of radial type containing about 43% by weight of styrene block and 50 phr of aromatic oil (Polimeri Europa);
Polystyrene: recycled polystyrene (Socotech Verona S.p.A.);
Vulcanized rubber: cryogenically ground waste rubber from scrap tires (<0.1 mm (140 mesh)—Applied Cryogenics International AG).

The mechanical characteristics (i.e. stress at break and elongation at break), the DIN abrasion values, and the MFI, were measured as above reported: the obtained data are given in Table 4.

TABLE 4

EXAMPLE

| | 3(*) | 4 |
|---|---|---|
| Stress at break (MPa) | 6.7 | 8.1 |
| Elongation at break (%) | 369 | 421 |
| DIN abrasion (mm³) | 146 | 117 |
| MFI (5 Kg - 190° C.) | 9.7 | 4.0 |

(*)comparative.

The data reported in Table 4 show that the thermoplastic elastomeric material according to the present invention (Example 4) has, with respect to the comparative composition comprising a vulcanized rubber in a subdivided form devoid of the coupling agent (Example 3), improved mechanical properties, in particular stress at break and elongation at break and improved abrasion resistance. Moreover, the Melt Flow Index (MFI) is not negatively affected.

### EXAMPLES 5-6

Preparation of the Thermoplastic Elastomeric Materials

The thermoplastic elastomeric materials given in Table 5 were prepared as follows.

The Europrene® SOL T171 (a), the vulcanized rubber (c) and the maleic anhydride (d), were mixed together in an internal mixer (model Pomini PL 1.6) for about 2 min. As soon as the temperature reached 190° C., a degassing step of 1 minutes was carried out, the polystyrene (b) and the K-Resin® KRO1 (b) were then added and the mixture was mixed for about 5 min. Then the mixture was discharged. The obtained mixture was subsequently charged in an open roll mixer operating at a temperature of 150° C. in order to obtain a sheet 1 mm thick.

TABLE 5

EXAMPLE

| | 3⁽*⁾ | 4 |
|---|---|---|
| Europrene ® SOL T171⁽¹⁾ | 52.6 | 52.6 |
| Polystyrene⁽¹⁾ | 27.8 | 27.8 |
| K-Resin ® KR01⁽¹⁾ | 19.6 | 19.6 |
| Vulcanized rubber⁽²⁾ | 24.7 | 24.7 |
| Maleic anhydride⁽²⁾ | — | 2.5 |

⁽*⁾comparative;
⁽¹⁾(a) + (b) = 100;
⁽²⁾parts by weight with respect to 100 parts by weight of (a) + (b).

Europrene® SOL T171: styrene-butadiene-styrene triblock copolymer of radial type containing about 43% by weight of styrene block and 50 phr of aromatic oil (Polimeri Europa);
Polystyrene: recycled polystyrene (Socotech Verona S.p.A.);
K-Resin® KRO1: styrene-butadiene copolymer containing about 75% of styrene (Chevron Phillips);
Vulcanized rubber: cryogenically ground waste rubber from scrap tires (<0.1 mm (140 mesh)—Applied Cryogenics International AG).

The mechanical characteristics (i.e. stress at break and elongation at break), the DIN abrasion values, and the MFI, were measured as above reported: the obtained data are given in Table 6.

TABLE 6

EXAMPLE

| | 5(*) | 6 |
|---|---|---|
| Stress at break (MPa) | 8.1 | 9.1 |
| Elongation at break (%) | 434 | 506 |
| DIN abrasion (mm³) | 139 | 127 |
| MFI (5 Kg - 190° C.) | 11.7 | 3.2 |

(*)comparative.

The data reported in Table 6 show that the thermoplastic elastomeric material according to the present invention (Example 6) has, with respect to the comparative composition comprising a vulcanized rubber in a subdivided form devoid of the coupling agent (Example 5), improved mechanical properties, in particular stress at break and elongation at break and improved abrasion resistance. Moreover, the Melt Flow Index (MFI) is not negatively affected.

1-60. (canceled)

61. A thermoplastic elastomeric material comprising:
(a) 10% by weight to 100% by weight of at least one styrene-based thermoplastic elastomer;
(b) 0% by weight to 90% by weight of at least one thermoplastic α-olefin homopolymer or copolymer different from (a),
the amount of (a) +(b) being 100;
(c) 2 parts by weight to 90 parts by weight of a vulcanized rubber in a subdivided form; and
(d) 0.01 part by weight to 10 parts by weight of at least one coupling agent containing at least one ethylenic unsaturation,
the amounts of (c) and (d) being expressed with respect to 100 parts by weight of (a)+(b).

62. The thermoplastic elastomeric material according to claim 61, comprising:
(a) 20% by weight to 80% by weight of at least one styrene-based thermoplastic elastomer; and
(b) 20% by weight to 80% by weight of at least one thermoplastic α-olefin homopolymer or copolymer different from (a),
the amount of (a)+(b) being 100.

63. The thermoplastic elastomeric material according to claim 61, wherein the vulcanized rubber in a subdivided form (c) is present in an amount of 5 parts by weight to 40 parts by weight with respect to 100 parts by weight of (a)+(b).

64. The thermoplastic elastomeric material according to claim 61, wherein the coupling agent is present in an amount of 0.05 parts by weight to 5 parts by weight with respect to 100 parts by weight of (a)+(b).

65. The thermoplastic elastomeric material according to claim 61, wherein the styrene-based thermoplastic elastomer (a) comprises at least two terminal poly (monovinylaromatic hydrocarbon) blocks and at least one internal poly(conjugated diene) block and/or poly(aliphatic α-olefin) block.

66. The thermoplastic elastomeric material according to claim 65, wherein the styrene-based thermoplastic elastomer (a) is selected from block copolymers having the following formulae: A(BA)ₘ, A(BA′)ₘ, or (AB)ₙX, or (AB)ₚX(A′B′)_{q} or (AB)ᵣX (B″)ₛ, wherein each of A and A′ independently represent a polymer block comprising a monovinylidene aromatic monomer; B, B′ and B″ independently represent a polymer block comprising a conjugated diene monomer and/or an aliphatic α-olefin monomer; X represents a polyfunctional bridging moiety; n and r represent an integer not lower than 2; and m and m′ represent an integer ≧1; p, q and s represent an integer ≧1.

67. The thermoplastic elastomeric material according to claim 66, wherein the monovinylidene aromatic monomer of blocks A and A′ is selected from: styrene, alkyl-substituted styrenes, alkoxy-substituted styrenes, vinyl naphthalene, alkyl-substituted vinyl naphthalene, vinyl xylene, alkyl-substituted vinyl xylene, or mixtures thereof.

68. The thermoplastic elastomeric material according to claim 66, wherein the conjugated diene monomer of blocks B, B′ and B″, is selected from conjugated dienes containing from 4 to 24 carbon atoms, 1,3-butadiene, isoprene, 2-ethyl-1,3-butadiene, 2,3-dimethyl-1,3-butadiene, 2-phenyl-1,3-butadiene, 1,3-pentadiene, methylpentadiene, 3-ethyl-1,3-pentadiene, 2,4-hexadiene, 3,4-dimethyl-1,3-hexadiene, 4,5-diethyl-1,3-octadiene, piperylene, or mixtures thereof.

69. The thermoplastic elastomeric material according to claim 66, wherein the aliphatic α-olefin monomer is selected from ethylene, propylene, or mixtures thereof.

70. The thermoplastic elastomeric material according to claim 66, wherein the polyfunctional bridging moiety comprises from 2 to 8 functional groups.

71. The thermoplastic elastomeric material according to claim 66, wherein the block copolymers are selectively hydrogenated.

72. The thermoplastic elastomeric material according to claim 66, wherein the blocks A and A′ have a weight average molecular weight of 3,000 g/mol to 125,000 g/mol.

73. The thermoplastic elastomeric material according to claim 66, wherein the blocks B, B′ and B″ have a weight average molecular weight of 10,000 g/mol to 300,000 g/mol.

74. The thermoplastic elastomeric material according to claim 66, wherein the block copolymers have a total weight average molecular weight of 25,000 to 500,000.

75. The thermoplastic elastomeric material according to claim 66, wherein the block copolymer has a triblock structure and may be of the linear or radial type, or any combination thereof.

76. The thermoplastic elastomeric material according to claim 66, wherein the styrene-based thermoplastic elastomer (a) is selected from the following triblock copolymers: styrene-butadiene-styrene (S-B-S), styrene-isoprene-styrene (S-I-S), styrene-ethylene/butene-styrene (S-EB-S), or mixtures thereof.

77. The thermoplastic elastomeric material according to claim 61, wherein in the thermoplastic α-olefin homopolymer or copolymer (b) is different from (a), the α-olefin is an aliphatic or aromatic α-olefin of formula CH₂═CH—R, wherein R represents a hydrogen atom, a linear or branched alkyl group containing from 1 to 12 carbon atoms, or an aryl group having from 6 to 14 carbon atoms.

78. The thermoplastic elastomeric material according to claim 77, wherein the aliphatic α-olefin is selected from: ethylene, propylene, 1-butene, isobutylene, 1-pentene, 1-hexene, 3-methyl-1-butene, 3-methyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene, 1-eicosene, or mixture thereof.

79. The thermoplastic elastomeric material according to claim 77, wherein the aromatic α-olefin is selected from: styrene, α-methylstyrene, or mixtures thereof.

80. The thermoplastic elastomeric material according to claim 77, wherein the thermoplastic α-olefin homopolymer or copolymer (b) is selected from:
propylene homopolymers or copolymer of propylene with ethylene and/or an α-olefin having 4 to 12 carbon atoms with an overall content of ethylene and/or α-olefin lower than 10% by mole;
ethylene homopolymers or copolymers of ethylene with at least one α-olefin having 4 to 12 carbon atoms and, optionally, at least one polyene;
styrene polymers, styrene homopolymers, copolymers of styrene with at least one C₁-C₄ alkyl-styrene or with at least one natural or synthetic elastomer, polybutadiene, polyisoprene, butyl rubber, ethylene/propylene/diene copolymer (EPDM), ethylene/propylene copolymers (EPR), natural rubber, or epichlorohydrin;
copolymers of ethylene with at least one ethylenically unsaturated ester selected from: alkyl acrylates, alkyl methacrylates and vinyl carboxylate, wherein the alkyl group, linear or branched, has 1 to 8 carbon atoms, while the carboxylate group, linear or branched, has 2 to 8 carbon atoms; and wherein the ethylenically unsaturated ester is generally present in an amount of 0.1% to 80% by weight with respect to the total weight of the copolymer.

81. The thermoplastic elastomeric material according to claim 80, wherein the ethylene homopolymers or copolymers of ethylene with at least one α-olefin having 4 to 12 carbon atoms are selected from: low density polyethylene (LDPE), medium density polyethylene (MDPE), high density polyethylene (HDPE), linear low density polyethylene (LLDPE), ultra-low density polyethylene (ULDPE), or mixtures thereof.

82. The thermoplastic elastomeric material according to claim 80, wherein the copolymers of ethylene with at least one α-olefin having 4 to 12 carbon atoms, and optionally at least one polyene, are selected from:
elastomeric copolymers having the following monomer composition: 35 mol %-90 mol % of ethylene; 10 mol %-65 mol % of an aliphatic α-olefin; and 0 mol %-10 mol % of a polyene; and
copolymers having the following monomer composition: 75 mol %-97 mol % of ethylene; 3 mol %-25 mol % of an aliphatic α-olefin; and 0 mol %-5 mol % of a polyene.

83. The thermoplastic elastomeric material according to claim 80, wherein the styrene polymers, different from (a), are: syndiotactic polystyrene, atactic polystyrene, isotactic polystyrene, styrene-methylstyrene copolymer, styrene-isoprene copolymer or styrene-butadiene copolymer, styrene-ethylene/propylene (S-EP) or styrene-ethylene/butene (S-EB) diblock copolymers; styrene-butadiene or styrene-isoprene branched copolymers; or mixtures thereof.

84. The thermoplastic material according to claim 80, wherein the copolymers of ethylene with at least one ethylenically unsaturated ester are selected from: ethylene/vinylacetate copolymer (EVA), ethylene/ethylacrylate copolymer (EEA), ethylene/butylacrylate copolymer (EBA), or mixtures thereof.

85. The thermoplastic elastomeric material according to claim 61, wherein the vulcanized rubber in a subdivided form (c) has a particle size not higher than 10 mm.

86. The thermoplastic elastomeric material according to claim 85, wherein the vulcanized rubber in a subdivided form (c) has a particle size not higher than 5 mm.

87. The thermoplastic elastomeric material according to claim 61, wherein the vulcanized rubber in a subdivided form (c) has a particle size not higher than 0.5 mm.

88. The thermoplastic elastomeric material according to claim 87, wherein the vulcanized rubber in a subdivided form (c) has a particle size not higher than 0.2 mm.

89. The thermoplastic elastomeric material according to claim 88, wherein the vulcanized rubber in a subdivided form (c) has a particle size not higher than 0.1 mm.

90. The thermoplastic elastomeric material according to claim 61, wherein the vulcanized rubber in a subdivided form (c) comprises at least one crosslinked diene elastomeric polymer or copolymer of natural origin or obtained by solution polymerization, emulsion polymerization or gas-phase polymerization of one or more conjugated diolefins, optionally blended with at least one comonomer selected from monovinylarenes and/or polar comonomers in an amount of not more than 60% by weight.

91. The thermoplastic elastomeric material according to claim 90, wherein the crosslinked diene elastomeric polymer or copolymer is selected from: cis-1,4-polyisoprene, 3,4-polyisoprene, polybutadiene, optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

92. The thermoplastic elastomeric material according to claim 61, wherein the vulcanized rubber in a subdivided form (c) further comprises at least one crosslinked elastomeric polymer of one or more monoolefins with an olefinic comonomer or derivatives thereof.

93. The thermoplastic elastomeric material according to claim 92, wherein the crosslinked elastomeric polymer is selected from: ethylene/propylene copolymers (EPR) or ethylene/propylene/diene copolymers (EPDM), polyisobutene, butyl rubbers, halobutyl rubbers, chlorobutyl rubbers, bromobutyl rubbers, or mixtures thereof.

94. The thermoplastic elastomeric material according to claim 61, wherein the coupling agent containing at least one ethylenic unsaturation (d) is selected from: silane compounds containing at least one ethylenic unsaturation and at least one hydrolyzable group; epoxides containing at least one ethylenic unsaturation; monocarboxylic acids or dicarboxylic acids containing at least one ethylenic unsaturation, or derivatives thereof or organic titanates, zirconates or aluminates containing at least one ethylenic unsaturation.

95. The thermoplastic elastomeric material according to claim 94, wherein the silane compounds are selected from: γ-methacryloxypropyltrimethoxysilane, methyltriethoxy-silane, methyltris (2-methoxyethoxy) silane, dimethyl-diethoxysilane, vinyltris (2-methoxyethoxy) silane, vinyltrimethoxysilane, vinyltriethoxysilane, octyltri-ethoxysilane, isobutyltriethoxysilane, isobutyl-trimethoxysilane, or mixtures thereof.

96. The thermoplastic elastomeric material according to claim 94, wherein the epoxides are selected from: glycidyl acrylate, glycidyl methacrylate, monoglycidly ester of itaconic acid, glycidyl ester of maleic acid, vinyl glycidyl ether, allyl glycidyl ether, or mixtures thereof.

97. The thermoplastic elastomeric material according to claim 94, wherein the monocarboxylic or dicarboxylic acids, or derivatives thereof, are selected from: maleic acid, maleic anhydride, fumaric acid, citraconic acid, itaconic acid, acrylic acid, methacrylic acid, and anhydrides or esters derived therefrom, or mixtures thereof.

98. The thermoplastic elastomeric material according to claim 61, further comprising (e) at least one aromatic monocarboxylic or dicarboxylic acid or a derivative thereof, an anhydride derivative thereof or an ester derivative thereof.

99. The thermoplastic elastomeric material according to claim 98, wherein the aromatic monocarboxylic or dicarboxylic acid or a derivative thereof is selected from: benzoic acid, phthalic acid, phthalic anhydride, trimellitic anhydride, di-2-ethylhexyl phthalate, di-isodecyl phthalate, tris-2-ethylhexyl trimellitate, or mixtures thereof.

100. The thermoplastic elastomeric material according to claim 98 wherein the aromatic monocarboxylic or dicarboxylic acid or a derivative thereof is present in an amount of 0 part by weight to 10 parts by weight with respect to 100 parts by weight of (a)+(b).

101. The thermoplastic elastomeric material according to claim 100, wherein the aromatic monocarboxylic or dicarboxylic acid or a derivative thereof is present in an amount of 0.01 part by weight to 5 parts by weight with respect to 100 parts by weight of (a)+(b).

102. The thermoplastic elastomeric material according to claim 61, further comprising at least one inorganic filler.

103. The thermoplastic elastomeric material according to claim 102, wherein the inorganic filler is selected from: hydroxides, hydrated oxides, salts or hydrated salts of metals, calcium salts of metals, magnesium salts of metals or aluminium salts of metals, optionally in admixture with other inorganic fillers, silicates, carbon black, or mixtures thereof.

104. The thermoplastic elastomeric material according to claim 103, wherein the inorganic fillers are: magnesium hydroxide, aluminium hydroxide, aluminium oxide, aluminium trihydrate, magnesium carbonate hydrate, magnesium carbonate, calcium carbonate hydrate, calcium carbonate, magnesium calcium carbonate hydrate, magnesium calcium carbonate, or mixture thereof.

105. The thermoplastic elastomeric material according to claim 102, wherein the inorganic filler is present in an amount 0 part by weight to 200 parts by weight with respect to 100 parts by weight of (a)+(b).

106. The thermoplastic elastomeric material according to claim 105, wherein the inorganic filler is present in an amount of 10 parts by weight to 50 parts by weight, with respect to 100 parts by weight of (a)+(b).

107. The thermoplastic elastomeric material according to claim 61, further comprising at least one syndiotactic 1,2-polybutadiene.

108. The thermoplastic elastomeric material according to claim 107, wherein the syndiotactic 1,2-polybutadiene has an average molecular weight (number-average) of 75,000 to 200,000.

109. The thermoplastic elastomeric material according to claim 107, wherein the 1,2-polybutadiene has a crystallinity degree of 10% to 90%.

110. The thermoplastic elastomeric material according to claim 107, wherein the syndiotactic 1,2-polybutadiene is present in an amount of 0 part by weight to 300 parts by weight with respect to the 100 parts by weight of (a)+(b).

111. The thermoplastic elastomeric material according to claim 110, wherein the syndiotactic 1,2-polybutadiene is present in an amount of 5 parts by weight to 200 parts by weight, with respect to the 100 parts by weight of (a)+(b).

112. The thermoplastic elastomeric material according to claim 61, further comprising a radical initiator.

113. The thermoplastic elastomeric material according to claim 112, wherein the radical initiator is selected from organic peroxides, t-butyl perbenzoate, dicumyl peroxide, benzoyl peroxide, di-t-butyl peroxide, or mixtures thereof.

114. The thermoplastic elastomeric material according to claim 112, wherein the radical initiator is added in an amount of 0 part by weight to 5 parts by weight with respect to 100 parts by weight of (a)+(b).

115. The thermoplastic elastomeric material according to claim 114, wherein the radical initiator is added in an amount of 0.01 part by weight to 2 parts by weight with respect to 100 parts by weight of (a)+(b).

116. The thermoplastic elastomeric material according to claim 61, wherein the styrene-based thermoplastic elastomer (a) comprises conjugated diene monomers and the thermoplastic elastomeric material is substantially devoid of a radical initiator.

117. A manufactured product obtained by molding a thermoplastic elastomeric material according to claim 61.

118. A manufactured product comprising a thermoplastic elastomeric material according to claim 61.

119. The manufactured product according to claim 117, comprising shoe soles, shoe foxing, or shoe innersoles.

120. The manufactured product according to claim 117, comprising belts; flooring and footpaths; flooring tiles; mats; shock absorbers; sheetings; sound barriers; membrane protections; carpet underlay; automotive bumpers; wheel arch liner; seals; o-rings; gaskets; watering systems; pipes or hoses materials; flower pots; building blocks; roofing materials; or geomembranes.
